(19) United States
(12) Patent Application Publication
(10) Pub. No.: US 2018/0204022 A1
(43) Pub. Date: Jul. 19, 2018

(54) DATA RELATED RIGHTS AND POLICIES BASED ON CONTENT ANALYSIS OF DATA

(71) Applicant: Vaultize Technologies Private Limited, Pune (IN)

(72) Inventors: Ankur Panchbudhe, Pune (IN); Praneeth Siva, Pune (IN); Amol Vaikar, Pune (IN); Yusuf Batterywala, Pune (IN)

(73) Assignee: Vaultize Technologies Private Limited, Pune (IN)

(21) Appl. No.: 15/920,181

(22) Filed: Mar. 13, 2018

(51) Int. Cl. G06F 21/62; G06F 17/30; G06F 21/60

(52) U.S. Cl. CPC G06F 21/6218; G06F 21/604; G06F 17/30867

(57) ABSTRACT

The embodiments herein relate to management of data and, more particularly, to management of rights and policies of data based on analysis of data. The embodiments herein disclose a method and system for managing data access and associated rights based on analysis of content of a data. Embodiments herein disclose a method and system for managing access and rights associated with at least one set of data, wherein the access and sights are based on content of the data. The method and system can perform analysis of the content of the data; assign access and rights to each set of data (based on the analysis of the content of the data) and control access to the data based on the access and rights associated with the data.

### TECHNICAL FIELD

The embodiments herein relate to management of data and, more particularly, to management of rights and policies of data based on analysis of data.

### BACKGROUND

Currently, enterprises have data available with them, wherein the data can be present on servers (such as file servers, database servers, management servers, the Cloud, and so on), with users within the enterprise and so on. Previously, immobile workstations were used by users to access data (wherein the data can be information, software and so on) and it was easy for the enterprises to control access of data, in terms of the user and/or workstation having access to the data, the time that the user is accessing, operations performed by the user and so on.

However, with the proliferation of user devices such as laptops, tablets, mobile devices and so on, the data become accessible for the user from any location (typically referred to as anywhere access). In such a scenario, it becomes difficult for the enterprise to control access to the data. The enterprise would in an ideal situation, provide secure anywhere access in terms of access rights/permissions for data based on dimensions like who is accessing the data, when is the access happening (the time of the day, when the user is accessing the data), from where is the access happening (the device, geo-location or IP (Internet Protocol) address of the user accessing the data) and how/why is the access happening (read-only access, access for sharing, access for copy-pasting, access for saving and so on). These dimensions determine what access rights should a particular data have. However, these dimensions are restrictive in many cases because the rights over data are decided by factors external to the data.

### BRIEF DESCRIPTION OF THE FIGURES

The embodiments herein will be better understood from the following detailed description with reference to the drawings, in which:

FIG. 1 depicts a system for managing data in an enterprise environment, according to embodiments as disclosed herein;

FIG. 2 depicts the data access controller, according to embodiments as disclosed herein;

FIG. 3 is a flowchart illustrating the process of the data access controller assigning access rights/permission to data, according to embodiments as disclosed herein; and

FIG. 4 depicts a flowchart illustrating the process of the user attempting to access/use data, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

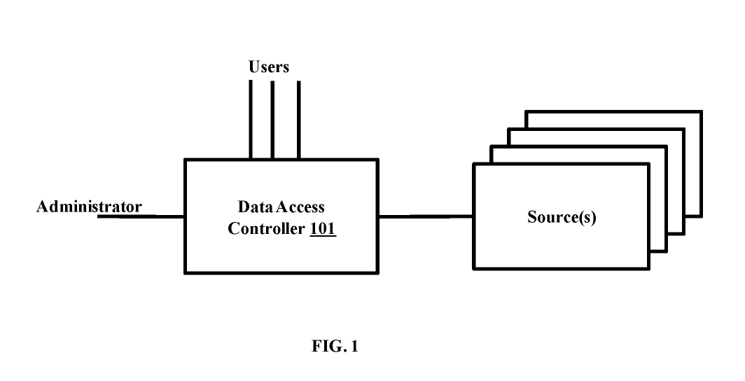

The embodiments herein disclose methods and systems for managing data access and associated rights based on analysis of content of a data. Referring now to the drawings, and more particularly to FIGS. 1 through 4, where similar reference characters denote corresponding features consistently throughout the figures, there are shown embodiments.

Embodiments herein disclose methods and systems for managing access and rights associated with at least one set of data, wherein the access and rights are based on content of the data. The methods and systems can perform analysis of the content of the data; assign access and rights to each set of data (based on the analysis of the content of the data) and control access to the data based on the access and rights associated with the data.

FIG. 1 depicts a system for managing data in an enterprise environment, according to embodiments as disclosed herein. The system comprises of a data access controller 101. The data access controller 101 can be connected to at least one source of data. The data can be information, software, emails, applications, software code, databases, and so on, wherein the data can be in the form of documents (Microsoft Office Formats, PDF, Open Document formats and so on), images, media files, lists (Comma Separated values, Spreadsheets), drawings, schematics, blue-prints and so on. The source of data can comprise of at least one database, a server (such as a file server, a database server, a content management server, an application server and so on), a memory and so on. The server can be any server configured to contain information; for example, a file server, a database server, a content management server and so on. The memory can be a dedicated memory device such as a hard disk, a SSD (Solid State Drive) and so on. The memory can also be a part of a device associated with the enterprise network such as a desktop, a laptop, a device belonging to the user (such as in a BYOD (Bring Your Own Device) scenario) such as a mobile phone, a tablet, a personal computing device, a wearable computing device, an IoT (Internet of Things) device, and so on, wherein the data access controller 101 has access to the memory. The data can be in any location suitable for storing data relevant to the enterprise.

The data access controller 101 can interface with at least one device, wherein the user can use this at least one device to access the data. The device can be at least one of a computer, desktop, laptop, a tablet, a server (such as a file server, a database server, a content management server, an application server and so on), a mobile device (such as a mobile phone, tablet and so on), a wearable computing device, an IoT device, and so on. The user can be an employee, a contractor, an agent, a client or any person and/or organization/enterprise, attempting to access the data (with authorization from the enterprise who owns the data or without appropriate authorization).

An administrator can be authorized to access the data access controller 101, wherein the administrator can view the data, associated access and rights, change the associated access and rights and so on. The administrator can also provide the location of data to the data access controller 101, wherein the data access controller 101 can process the content of the data. The administrator can also provide a location (a database, a memory and so on) to the data access controller 101, wherein the data access controller 101 can scan the location to check for data.

In an embodiment herein, the data access controller 101 can be a dedicated device such as a server, which is connected to the sources of data. In another embodiment herein, the data access controller 101 can be present on a device/server (for example, as an application, plugin, extension and so on) and can perform analysis of the content of the data present on that device; assign access and rights to each set of data (based on the analysis of the content of the data) present on that device and control access to the data based on the access rights associated with the data present on that device. In another embodiment herein, the data access controller 101 can be present on a device/server (for example, as an application, plugin, extension and so on) and can perform analysis of the content of the data present on that device and at least one other device; assign access and rights to each set of data (based on the analysis of the content of the data) present on that device and at least one other device and control access to the data based on the access and rights associated with the data present on that device and at least one other device. In another embodiment herein, the data access controller 101 can be a distributed device, wherein the functionality of the data access controller 101 can be distributed over one or more devices; such as a server and a device used by the user and so on.

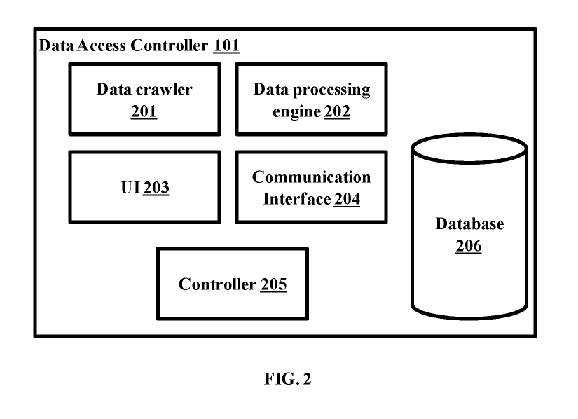

FIG. 2 depicts the data access controller, according to embodiments as disclosed herein. The data access controller 101, as depicted, comprises of a data crawler 201, a data processing engine 202, a User Interface (UI) 203, at least one communication interface 204, a controller 205 and a database 206.

The UI 203 can enable the administrator to interface with the data access controller 101. The UI 203 can be at least one of a graphical user interface, a text based interface or a combination of graphical and text based interfaces. The administrator can access the UI 203 using a computer, a laptop, a desktop, a mobile device, a wearable computing device, an IoT device,s or any other device configured to enable the administrator with the data access controller 101. The UI 203 can be accessed locally. The UI 203 can also be accessed remotely, wherein the administrator can access the data access controller 101 from a remote location.

The communication interface 204 can enable the data access controller 101 to communicate with at least one external entity, such as a data source and so on. The communication interface 204 can comprise of a LAN (Local Area Network) interface, a WAN (Wide Area Network) interface, IPC (Inter Process Communication), a wireless communication interface (Wi-Fi, cellular communications, Bluetooth and so on), the Internet, a private network interface and so on. The communication interface 204 can also enable the data access controller 101 to interact with other external entities such as user(s), administrator(s) and so on. The communication interface 204 can comprise of at least one of a web UI access, Application based Interface (API)-based access, FTP (File Transfer Protocol), SFTP (Secure FTP), FTPS (FTP Secure), SMTP (Simple Mail Transfer Protocol), CIFS/SMB (Common Internet File System/Server Message Block), NFS (Network File System), CIMS (Content Management Interoperability Services), ActiveSync, DAV (Distribution Authoring and Versioning), WebDAV, HTTP (Hypertext Transfer Protocol), HTTPS (HTTP Secure) and so on.

The database 206 can be a memory storage location, wherein the database 206 can be a pure database, a memory store, an electronic storage location, the Cloud, and so on. The database 206 can be located locally with the data access controller 101. The database 206 can be located remotely from the data access controller 101, wherein the data access controller 101 can communicate with the database 206 using a suitable means such as LAN, a private network, a WAN, the Internet, Wi-Fi and so on. The database 206 can comprise of policy rule(s) (as set by the administrator), default policy rule(s), metadata and so on.

The data crawler 201 can be configured to access and crawl through at least one source of data. The data crawler 201 can be configured by the administrator, wherein the administrator can provide the data crawler 201 with information on where the data is located, the specific type(s) of data to crawl and so on. The data crawler 201 can be configured to crawl data source(s) at pre-configured time intervals, to check for new data to crawl. The data crawler 201 can be configured to crawl data sources based on occurrence of an event, such as creation of new data, modification of existing data, a user attempting to access the data (in real-time) and so on. The data crawler 201 can discover, browse and crawl the data. The data crawler 201 provides crawled content (from the data) to the data processing engine 202.

The data processing engine 202 can be configured to receive the crawled content from the data crawler 201. The data processing engine 202 performs analysis of the crawled content. The analysis can be performed using at least one content analysis technique such as classification (into at least one of categories, tags, labels and so on, based on the content of the data), document clustering, keyword extraction, natural language processing, collaborative filtering, pattern matching or any other suitable content analysis technique. Based on the analysis, the data processing engine 202 generates a set of metadata. The generated metadata can comprise of category, label and/or label of the data, keywords of the data, information about any pre-described patterns inside the data, meaning or key-phrases about the data, scores, emotions, text or non-text patterns and so on.

In an example, consider that the crawled data comprises of a list of credit card numbers belonging to a plurality of users. The data processing engine 202 analyzes the data and classifies the data by classifying the data as very sensitive data and assigning a label as ‘credit card’. The data processing engine 202 further generates metadata, such as the label—‘credit card’, category—sensitive data and so on. The administrator can also provide inputs to the data processing engine 202, wherein the data processing engine 202 can add, remove or modify metadata based on the inputs.

The controller 205 can receive information such as the metadata from the data processing engine 202. The controller 205 can further present the data along with the metadata to the administrator. The controller 205 can enable the administrator to set access rights/permissions using the UI 203. The controller 205 can enable the administrator to set access rights/permissions using the UI 203 for the whole data. The controller 205 can enable the administrator to set the access rights/permissions using the UI 203 for a subset of data from the data. The controller 205 can enable the administrator to set the access rights/permissions using the UI 203 for each individual data separately. The administrator can decide on the access rights/permission, based on the data and/or the metadata.

The controller 205 can decide on the access rights/permissions using at least one pre-defined policy (wherein each policy can comprise of access rights/permissions), wherein the policies are defined based on the metadata. The administrator can define the rules of the policy. The controller 205 can create the rules, based on prior defined rules, as provided by the administrator. The controller 205 can over time, automatically refine the rules as the administrator provides rules for new data. The administrator can edit the access rights/permissions, at any instant.

The access rights/permission can comprise of who is accessing the data, when is the access happening (the time of the day, when the user is accessing the data), from where is the access happening (the device, geo-location or IP (Internet Protocol) address of the user accessing the data) and how/why is the access happening (read-only access, access for sharing, access for copy-pasting, access for saving and so on). Examples of access rights/permissions are (but not limited to) view-only access, download access, upload access, read access, write access, edit access, export/Save-As access, delete access, rename access, listing/browse access (for folders), forward access, emailing access, sharing access, copy-paste access, access only in watermarked form, access only in certain file format (for example, only as a non-editable PDF), access only in encrypted form, access only in DRM/IRM (Digital Rights Management/Information Rights Management) protected form and so on.

On a user attempting to access/use the data, the controller 205 checks if the user has the access rights/permissions to access/use the data. If the controller 205 confirms that the user has access rights/permissions to access/use the data, the controller 205 enables the user to access the data. If the controller 205 confirms that the user has no access rights/permissions to access/use the data, the controller 205 denies the user access/use to the data. The controller 205 can be configured to check the access rights/permission of the user, on every action performed by the user on the data (such as copying data, printing data, editing data and so on).

In an embodiment herein, the data access controller 101 can control how the user uses and/or accesses the data, if the user has the access rights/permissions to access/use the data. The data access controller 101 can enable this by performing at least one action such as converting the data into a format (as desired by the user), setting at least one default option (such as an option related to viewing, formatting and so on) as configured by the user and so on.

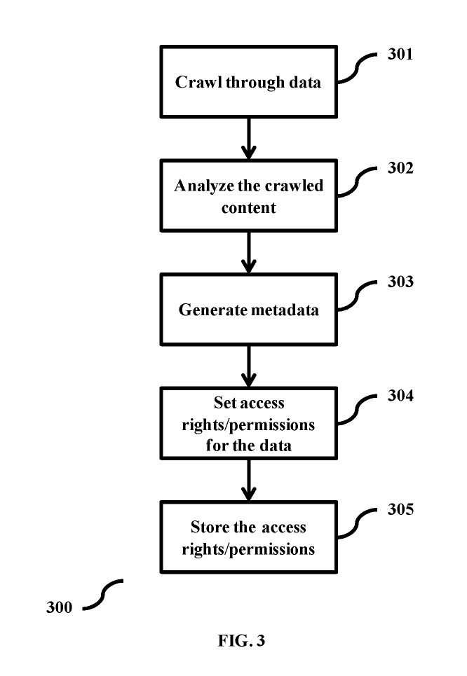

FIG. 3 is a flowchart illustrating the process of the data access controller assigning access rights/permission to data, according to embodiments as disclosed herein. The data access controller 101 accesses and crawls (301) through at least one source of data. The data access controller 101 can crawl data source(s) at pre-configured time intervals, to check for new data to crawl. The data access controller 101 can discover, browse and crawl the data. The data access controller 101 performs analysis (302) of the crawled content. The data access controller 101 can perform analysis using at least one content analysis technique such as classification (into at least one of categories, tags, labels and so on, based on the content of the data), document clustering, keyword extraction, natural language processing, collaborative filtering, pattern matching or any other suitable content analysis technique. Based on the analysis, the data access controller 101 generates (303) a set of metadata. The generated metadata can comprise of category, label and/or label of the data, keywords of the data, information about any pre-described patterns inside the data, meaning or key-phrases about the data and so on. The data access controller 101 further sets (304) access rights/permissions for the data. The administrator can set the access rights/permissions. The administrator can also set at least one policy based on the meta-data. The data access controller 101 can configure the access rights/permissions automatically using at least one pre-defined policy. In an embodiment herein, the data access controller 101 can create at least one policy. The data access controller 101 can use a suitable means such as heuristics, machine learning, non-linear programming and so on to create at least one policy. In an embodiment herein, the data access controller 101 can create at least one rule. The data access controller 101 can use a suitable means such as heuristics, machine learning, non-linear programming and so on to create at least one rule. The policies and rules can be configured by the administrator and/or the data access controller 101 at any point in time, wherein the configuration can be at least one of addition, deletion, modification and so on. The data access controller 101 stores (305) the access rights/permissions along with the metadata. The various actions in method 300 may be performed in the order presented, in a different order or simultaneously. Further, in some embodiments, some actions listed in FIG. 3 may be omitted.

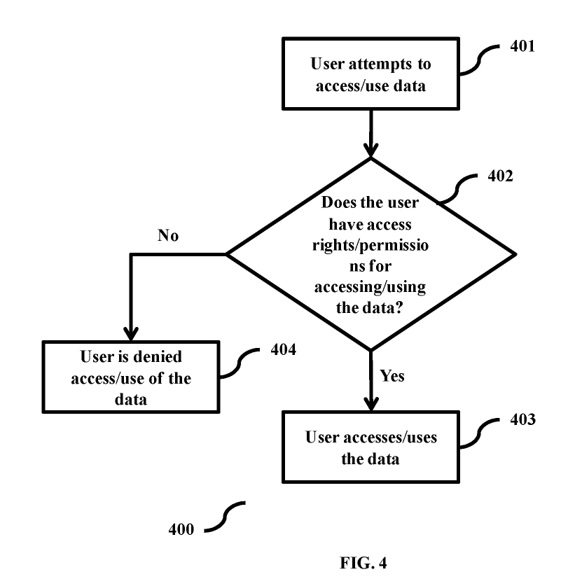

FIG. 4 depicts a flowchart illustrating the process of the user attempting to access/use data, according to embodiments as disclosed herein. On a user attempting (401) to access/use the data, the data access controller 101 checks (402) if the user has the access rights/permissions to access/use the data. If the data access controller 101 confirms that the user has access rights/permissions to access/use the data, the data access controller 101 enables (403) the user to access the data. If the controller 205 confirms that the user has no access rights/permissions to access/use the data, the controller 205 denies (404) the user access/use to the data. The various actions in method 400 may be performed in the order presented, in a different order or simultaneously. Further, in some embodiments, some actions listed in FIG. 4 may be omitted.

Embodiments disclosed herein enable a secure method and system access to data by using content/information analysis of the concerned data, which gives a more accurate way of controlling the access/usage of that data.

The embodiments disclosed herein can be implemented through at least one software program running on at least one hardware device and performing network management functions to control the network elements. The network elements shown in FIGS. 1 and 2 include blocks, which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for managing access to data by a data access controller, wherein at least one user is allowed to access each of the data based on at least one access right associated with each of the data, wherein the at least one access right is based on contents of the data.

2. The method, as claimed in claim 1, wherein the method further comprises of
crawling at least one data present in at least one source of data by the data access controller;
generating a set of metadata for each of the crawled data by the data access controller, on the data access controller analyzing the crawled data, wherein the set of metadata comprises of at least one metadata; and
assigning the at least one access right to the crawled data by the data access controller based on the metadata.

3. The method, as claimed in claim 2, wherein the data access controller crawls the at least one data at at least one of at pre-defined intervals, an event occurring; and in real-time.

4. The method, as claimed in claim 2, wherein assigning the at least one access right to the crawled data by the data access controller comprises of an administrator providing the at least one access right.

5. The method, as claimed in claim 2, wherein assigning the at least one access right to the crawled data by the data access controller comprises of the data access controller automatically assigning the at least one access right, based on the metadata.

6. The method, as claimed in claim 2, wherein the method further comprises of assigning the at least one access right to the crawled data by the data access controller based on the metadata based on at least one policy.

7. The method, as claimed in claim 6, wherein the at least one policy can be configured by at least one of the administrator and the data access controller.

8. A system for managing access to data, wherein the system is configured for allowing at least one user to access each of the data based on at least one access right associated with each of the data, wherein the at least one access right is based on contents of the data.

9. The system, as claimed in claim 8, wherein the system is further configured for
crawling at least one data present in at least one source of data;
generating a set of metadata for each of the crawled data, on the system analyzing the crawled data, wherein the set of metadata comprises of at least one metadata; and
assigning the at least one access right to the crawled data based on the metadata.

10. The system, as claimed in claim 9, wherein the system is further configured for crawling the at least one data at at least one of at pre-defined intervals, an event occurring; and in real-time.

11. The system, as claimed in claim 9, wherein the system is further configured for assigning the at least one access right to the crawled data by enabling an administrator to provide the at least one access right.

12. The system, as claimed in claim 9, wherein the system is further configured for assigning the at least one access right to the crawled data by automatically assigning the at least one access right, based \on the metadata.

13. The system, as claimed in claim 9, wherein the system is further configured for assigning the at least one access right to the crawled data based on the metadata based on at least one policy.

14. The system, as claimed in claim 13, wherein the system is further configured for enabling at least one of the administrator and the data access controller to configure the at least one policy.
